(19) United States
(12) Patent Application Publication
(10) Pub. No.: US 2007/0061269 A1
(43) Pub. Date: Mar. 15, 2007

(54) Apparatus and method for licensing

(76) Inventor: Ivan Dimkovic, Berlin (DE)

Correspondence Address: GLENN PATENT GROUP, 3475 EDISON WAY, SUITE L, MENLO PARK, CA, 94025, US

(21) Appl. No.: 11/238,884

(22) Filed: Sep. 28, 2005

Related U.S. Application Data
(63) Continuation of application No. PCT/EP05/09947, filed on Sep. 15, 2005.

(51) Int. Cl. G06Q 99/00

(52) U.S. Cl. 705/59

(57) ABSTRACT

In an apparatus for enabling the usage of an information package in an execution unit a provider is arranged, which is configured for storing license data wherein the information package is personalized to a user by said license data assigned to the information package. Furthermore, the execution unit is located exterior to the certification apparatus for enabling wherein the certification apparatus is a portable electronic device. Additionally, the apparatus comprises a communication interface, which is configured for receiving a command and, in response to the command for transmitting the license data or an authorization signal generated on the basis of the license data to the execution unit in order to enable the usage of the information package in the execution unit.

### CROSS-REFERENCE TO RELATED APPLICATIONS

This application is a continuation of co-pending International Application No. PCT/EP2005/009947, titled APPARATUS AND METHOD FOR LICENSING filed Sep. 15, 2005, which designated the United States and was not published in English.

### BACKGROUND OF THE INVENTION

1. Field of the Invention

The present invention refers to the technical field of digital certification and especially to the field of transferring and granting rights for use of a digital content like, for example, audio or video data or computer programs.

2. Description of the Related Art

Modern times have brought many issues with regard to digital content use. Unlike old technologies, it is now possible for a person with ordinary skills in the art to make perfect copies of the content and possibly violate rights granted to them by the content owner.

The current state of the art includes means to prevent possible content misuse by application of digital rights management. Herein rights associated with the specific content are checked on a computer, for example, the computer in which the content is to be used. As content, a digital audio file or a computer program can be considered, for which rights for using this content can be obtained by the owner, that is the music label or the software company. If no rights exist or there exists an incorrect or tempered rights “certificate”, a content shall not be accessible for use and/or be prevented to be accessed by a computer or a consumer electronic device like, for example, an MP3-player. Further examples for contents are video files like famous movies, which shall be projected by a video recorder, wherein for the projection a right to display the movie is necessary. Usually, rights to use are stored as data blocks inside the contents digital representation, for example a file or a data stream, or are stored as part of a bundle including a file (i.e. network streaming sessions). However, in most cases, these rights have to be physically delivered by some means to a target device, either by the user carrying the media with the appropriate rights object (i.e. secure optical disc) or by the device itself by connecting to a remote server, typically on the internet.

In both cases, a user has to prove that he is actually an owner of the license. In order to accomplish this, most state of the art solutions are accomplished by simply limiting the user's rights to a certain number of copies in storing the copies to, for example, a DRM enforced medium with no further rights to copy—such as, for example, an SD-card etc. . . . . As another alternative for proving that the user is actually an owner of the license, a method can be implemented in which a user is required to enter some identification phrase that would reveal his private data (i.e. his shopping account, credit card, . . . ) such that anyone to whom he gives his identification to would have knowledge about this private data, hence effectively preventing a user from giving away the identification phrase to any other person.

However, both of these methods have certain disadvantages for the user. For example, the first method, i.e. the DRM enforced medium, limits the user's ability to copy the medium to only a specific kind of medium, requiring that he must be in possession of a compatible target device everywhere he intends to use the content. Furthermore, the second method has the disadvantage that it includes a hassle of remembering and entering the identification phrase, which provides a further potential security risk if the target device could “sniff” or “spy” the phrase and expose the user's private data to another party (i.e. a computer virus can be configured to sniff or spy such data, etc.).

### SUMMARY OF THE INVENTION

Therefore, it is the object of the present invention to provide a more secure and easier way of granting rights for use of the content on different devices.

In accordance with a first aspect, the present invention provides an apparatus for enabling a usage of an information package in an execution unit the execution unit being located exterior to the apparatus for enabling, wherein the apparatus is a portable electronic device and wherein the information package is personalized to a user by license data being assigned to the information package, the apparatus comprising:

a provider being configured for providing the license data; and

a communication interface being configured for receiving a command relating to the information package, wherein the communication interface is furthermore configured to, in response to the command, check, whether license data related to the information package are provided by the provider, and, when the license data are in the provider, transmit the license data or an authorization signal generated on the basis of the license data to the execution unit in order to enable the usage of the information package in the execution unit.

In accordance with a second aspect, the present invention provides a method for licensing in an apparatus for enabling a usage of an information package in an execution unit, the execution unit being located exterior to the apparatus for enabling, wherein the apparatus is a portable electronic device and wherein the information package is personalized to a user by license data being assigned to the information package, the apparatus comprising:

a provider being configured for providing the license data; and

a communication interface being configured for receiving a command relating to the information package, wherein the communication interface is furthermore configured to, in response to the command, check, whether license data related to the information package are provided by the provider, and, when the license data are in the provider, transmit the license data or an authorization signal generated on the basis of the license data to the execution unit in order to enable the usage of the information package in the execution unit, wherein the method comprises the steps of:

receiving a command; and,

in response to the command, transmitting the license data or the authorization signal generated on the basis of the license data to the execution unit in order to enable the usage of the information package in the execution unit.

In accordance with a third aspect, the present invention provides an execution apparatus for using an information package, the information package being personalized to a user by license data assigned to the information package, wherein the license data is stored in a certification unit exterior to the execution apparatus, the execution apparatus comprising:

a storage means being configured for storing the information package and an enabling value;

a communication interface being configured for receiving an authorization code or an authorization signal from the certification unit, the authorization signal being generated in the certification unit on the basis of the license data stored in a storage means of the certification unit; and

a processor being configured for using the information included in the information package, if the authorization code or the authorization signal is in a predefined relation with the enabling value and for not using the information of the information package if the authorization code or the authorization signal is not in the predefined relation with the enabling value.

In accordance with a fourth aspect, the present invention provides a method for executing an information package using an execution apparatus, the information package being personalized to a user by license data being assigned to the information package, wherein the license data is stored in a certification unit exterior to the execution apparatus, the execution apparatus comprising

a storage means being configured for storing the information package and enabling value,

a communication interface being configured for transmitting a read-out signal to the certification unit and, in response to the read-out signal, for receiving an authorization code or an authorization signal from the certification unit, the authorization signal being generated in the certification unit on the basis of the license data stored in a storage means of the certification unit and

a processor being configured for using the information included in the information package, if the authorization code or the authorization signal is in a predefined relation with the enabling value and for not using the information of the information package if the authorization code or the authorization signal is not in the predefined relation with the enabling value,

wherein the method comprises the steps of:

receiving an authorization code or an authorization signal from the certification unit, the authorization signal being generated in the certification unit on the basis of the license data stored in a storage means of the certification unit; and

using the information included in the information package, if the authorization code or the authorization signal is in a predefined relation with the enabling value and not using the information of the information package if the authorization code or the authorization signal is not in the predefined relation with the enabling value.

In accordance with a fifth and sixth aspect, the present invention provides a computer program having a program code for performing one of the above mentioned methods, respectively, when the computer program runs on a computer.

The present invention is based on the finding that a more secure and easier way of granting rights for use of a content, for example, an audio or video file or a computer program which is to be used, can be realized when a license or license data is preferably stored independently and separately from a target content. Especially in a digital content rights management, a license, for example, for playing an MP3-file can be stored on a portable electronic device such as (but not limited to) a mobile phone, a personal digital assistant (PDA), or a digital watch, which have enough storage space to store the licensed object. This approach for a digital content rights management is based on modern digital lifestyle, in which most of the consumers already have personal electronic devices, which are being carried by themselves during most of their active time. Typically, a portable electronic device (PED) well known to everyone is a mobile phone, i.e. a cellular phone.

Modern PEDs usually have enough storage space abilities for implementing the present invention such that a usage of a user's PED can be considered to be a reliable method of the transport of the rights object, that is the license data. Expressed in other words, a license assigned to a user for running an MP3-file, a video file, or for running a computer program, can be stored in a memory of the user's mobile phone, the user's personal digital assistant (PDA), or the user's digital watch (SPOT). In this case, the content to be certified (including the MP3-file or video file to be played, or the computer program to be run) could then be separately copied on any kind of medium and to any kind of device using means to communicate with the PED. If the user then wishes to use the content (that is to play the MP3-file, the video file, or to run the computer program), he will just have to be in physical proximity of the target device (that is the MP3-player, the video player, or the computer) and, preferably, he would have to press a button or a combination of buttons on the PED to authorize the use of the content in the target device. In this way both of the issues associated with the modern state-of-the-art rights management technologies can be addressed, that is a possible content misuse can be prevented and a user must not be limited in the number of copies of the content he is allowed to do.

Thus, the present invention provides the advantage that an easier way of licensing the usage of a content on any target device can be realized and furthermore, an improved security can be achieved for the owner of the digital content.

Furthermore, the separation of the license data and the actual content data provides several additional advantages which are for example:
It gives people more freedom to copy and utilize the content on several devices they own or at least have access to. With embedded licensing data, a file is usually “locked-in” to one computer or device and a regular file copying would render the file useless on the target device—which is a big disadvantage of many DRM system of today.
It enables companies to share the files over the P2P networks (like torrent networks), without a fear that the files will be compromised—because the target users need the last part, i.e. the licensing data, to be able to use the content (advanced implementations of the invention would be able to give these “P2P unauthorized” users partial access to the file—i.e. only for few seconds, or with a degraded quality—with ability to still obtain a real license)
It also enables individuals to share files more easily as well, even some personal related documents, software or content, via internet networks without too much fear that unauthorized people would be able to access the content.

### BRIEF DESCRIPTION OF THE DRAWINGS

Preferred embodiments of the present invention are explained in more detail in the following with reference to the accompanying drawing, in which:

FIG. 1 shows a schematic arrangement for implementing the inventive approach

### DESCRIPTION OF THE PREFERRED EMBODIMENTS

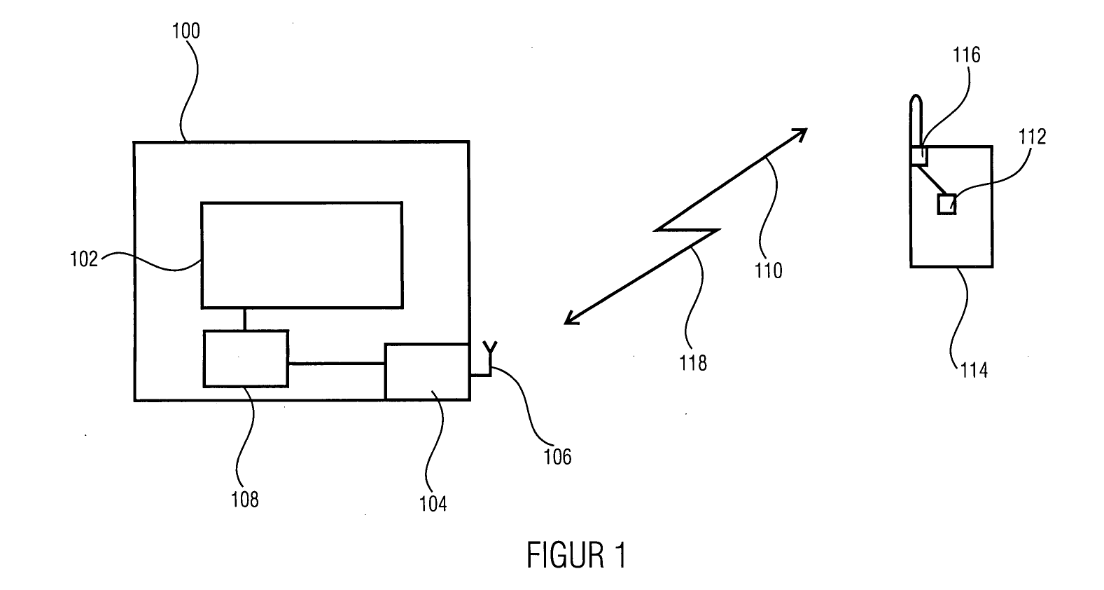

In FIG. 1 a target device 100 is shown, which can be, for example, a MP3-player, a video-player or a computer. An information package 102, for example an MP3-file, a video-file, or a computer program is stored on a storage medium in the target device 100. However, in order to use the information package 102, a license or license data is required, which is not stored on the target device 100. This license data can be for example a license code, which is required for executing or using the information package 102, that is, for playing the MP3-file, the video-file, or for running the computer program. In order to obtain the license data or information about the license data, a communication interface 104 is provided in a target device 100, which can be implemented with an antenna 106 in order to wirelessly receive data from exterior of the target device 100.

Further, it is necessary for using the information package 102 in the target device 100 that the target device 100 or at least a processor 108 is provided with an information that the right to use the information package 102 is assigned to a user of the target device 100. Therefore, the communication interface 104 can transmit (preferably via the antenna 106) a read-out signal 110 to a portable electronic device 112, which can be, for example, a mobile phone (i.e. cellular phone), a personal digital assistant (PDA), or a digital watch (SPOT) but also any other portable electronic device, which is used in the modern digital lifestyle. In this portable digital device 112 a storage means 114 is arranged, in which a digital license object (i.e. the license data), for example, a license code assigned to the owner or user of the portable electronic device 112, is stored. Preferably, the license object stored in the storage means 114 should be assigned to the owner or user of the portable electronic device 112 in order to run or execute the information package 102 in the target device 100. This means that, if the information package 102, for example the MP3-file, is licensed for a single user, the user shall store the license object in the storage medium 114 of his portable digital device 112, thus separating the information package 102 from the assigned license code. However, it is also possible that a user has a external special license provider (provider=storage means) on which the license data is stored an which will be contacted (e.g. by a secure wireless communication link) for providing the license data to the communication interface in the case, a user presses a button or a read-out signal 110 is received by the portable electronic device 112. If now the portable electronic device 112 receives the read-out signal 110 (preferably wirelessly) via a further communication interface 116, the licensed object stored in the storage means 114 of the portable electronic device 112 is read out and either directly transferred back to the communication interface 104 of the target device 100, or an authorization signal 118 is generated on the basis of the licensed object stored in the storage means 114 of the portable electronic device 112. This authorization signal 118 can, for example, include an encrypted version of the license object so as to provide a secure transmission of the license object from the portable electronic device 112 to the target device 100. Furthermore, the certification process can also be implemented such that not the license object is transferred from the portable electronic device 112 to the target device 100, but a single information in the form of a simple “yes” or “no” is transferred from the portable electronic device 112 to the target device 100, indicating whether the information package 102 is licensed to the owner/user of the portable electronic device 112 or the owner/user of the target device 100 such that the information package 102 can be used on the target device 100. Thus, the processor 108 of the target device 100, which is connected to the communication interface 104 and which has access to the information package 102 can be programmed such that if the authorization code received from the communication interface 116 of the portable electronic device 112 (which should preferably be the license object), or the authorization signal 118 is in a predefined relation with an enabling value. This predefined relation can either be such that the enabling value is a version of the license code such that a simple comparison of the received authorization signal with the enabling value reveals whether the received information about the license is equal to the stored version of the expected license information. In another alternative, the license object is encrypted in the portable electronic device 112 and the processor 108 then performs a decryption in order to extract the license object from the received authorization signal 118. In an other embodiment, in which just the “yes” or “no” is transmitted as an authorization signal 118, the processor 118 can be programmed such that, in response to a thus configured authorization signal 118, the information package 102 is used, that is the MP3-file or video file is played or the computer program is run. In the later described embodiment, a comparison whether the information package 102 and the target device 100 are licensed has to be performed in the portable electronic device 112. In order to accomplish this, the target device 100 has to submit further information about the information package 102 via the communication interface 104 in the read-out signal 110 such that the portable electronic device 112 has information about which information package 102 certification is requested and for which user the information package 102 is registered.

A further typical embodiment of the present invention would be a component residing, for example, on a user's mobile phone (e.g. smart phone) or another remote device with abilities to grant/refuse rights as, for example, a personal digital assistant (PDA). Connection functionality would be provided by the remote device itself. The connection between the remote device and the target device can be for example blue tooth, infrared connection (IrDa, Wireless LAN (WiFi), USB connection, or a packet link over radio frequencies like GPRS or UMTS). Therefore, the communication interface 104 of the target device 100 and the communication interface 116 of the portable electronic device 112 can be either a wireless or a wire line connection.

A component (storage means 114 as shown in FIG. 1) residing on the mobile phone 112 can thus have means to securely store the license/rights data associated to specify the customer, who is in possession of said mobile phone and to grant/refuse giving specific rights stored and the license/rights data to any device trying to retrieve this data remotely. Thus, a kind of “digital passport” can be implemented in which the portable electronic device 112, as shown in FIG. 1, acts as “digital passport” in order to indicate that the user or owner of the portable electronic device 112 has the right to use the information package 102 on the target device. This means, that the “digital passport” can, in this embodiment, only be retrieved from a portable electronic device which is personalized for the user.

The target device 100, for example, a DVD player, PC computer/notebook, home entertainment system or any other device for using digital data could read the digital content, that is the information package 102, and will deduct that the content needs a right or authorization to be executed. In addition, it could be necessary that a decryption key is stored in a license meta data as to decrypt a signal including the respective license in order to determine whether the user of the target device is authorized to execute or use the content of the information package 102. Then, the target device 100 can send a request to the portable electronic device 112, for example, the mobile phone, via the communication interface 104 (that is a remote link) in order to request a grant of the right to play the specific content included in the information package 102. The communication between the target device 100 and the mobile component (that is the portable electronic device 112) could be implemented by means of secure data exchange protocols such as by using an encryption algorithm in the portable electronic device 112 and the decryption algorithm in the target device 100 or vice versa.

Upon receiving the request, the mobile component would have an option to ask the person in possession of the mobile phone to permit or refuse the granting of the rights to the target device—and response appropriately—either by giving license rights to the target device over a remote data exchange protocol—or by refusing the request and transmitting no rights to the target device for using the content or the information package 102.

Furthermore, it is also possible that a owner of a content licenses the user to use the content only in a restricted geographical area, in order to prevent an unlimited distribution over the whole world. In this embodiment, the license being assigned to the user of the information package can include information about this licensed geographical area. Then, the target device 100 can detect its own geographical position (for example via an GPS receiver) and can send this position to the portable electronic device which can verify, whether the detected geographical position is in accordance with the licensed geographical position and, in response to this verification, the right to use the content can be issued or rejected.

Depending on certain implementation requirements, the inventive methods can be implemented in hardware or in software. The implementation can be performed using a digital storage medium, in particular a disk or a CD having electronically readable control signals stored thereon, which can cooperate with a programmable computer system such that the inventive methods are performed. Generally, the present invention is therefore a computer program product with a program code stored on a machine-readable carrier, the program code performing the inventive methods when the computer program runs on a computer. In other words, the inventive methods are therefore a computer program having a program code for performing the inventive methods, when the computer program runs on a computer.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. Apparatus for enabling a usage of an information package in an execution unit, the execution unit being located exterior to the apparatus for enabling, wherein the apparatus is a portable electronic device and wherein the information package is personalized to a user by license data being assigned to the information package, the apparatus comprising:
a provider being configured for providing the license data; and
a communication interface being configured for receiving a command relating to the information package, wherein the communication interface is furthermore configured to, in response to the command, check, whether license data related to the information package are provided by the provider, and, when the license data are in the provider, transmit the license data or an authorization signal generated on the basis of the license data to the execution unit in order to enable the usage of the information package in the execution unit.

2. Apparatus according to claim 1, wherein the communication interface is configured for receiving a read-out signal from the execution unit as the command.

3. Apparatus according to claim 1, wherein the provider is a storage being located in the apparatus.

4. Apparatus according to claim 1, wherein the apparatus is personalized for the user.

5. Apparatus according to claim 1, wherein the communication interface further comprises a license management unit for controlling a transmittal of the license data or the authorization signal to the execution unit, the license management unit being configured for requesting an input signal from a user and for transmitting the license data or the authorization signal to the execution unit in response to the input signal.

6. Apparatus according to claim 1, wherein the communication interface is configured for wirelessly transmitting the license data or the authorization signal to the execution unit.

7. Apparatus according to claim 1, wherein the communication interface is furthermore configure for decrypting the received read-out signal using a decryption key after reception or for encrypting the license data or the authorization signal before transmission to the execution unit using a decryption key.

8. Apparatus according to claim 1, wherein the communication interface is configured for extracting an identification information from the read-out signal, wherein the communication interface is furthermore configured for identifying from the identification information an assignment of the license data to the information package.

9. Apparatus according to claim 5, wherein the communication interface is configured for not transmitting the license data or for not transmitting the authorization signal to the execution unit if an assignment of the license data to the information package is not deducible from the identification information.

10. Apparatus according to claim 8, wherein the communication interface comprises a counter being configured for counting a number of transmissions of the license data or a number of transmissions of an authorization signal and wherein the communication interface is further configured for not transmitting the license data or for not transmitting an authorization signal, if in the counter a predefined number of transmissions is reached.

11. Apparatus according to claim 8, wherein the communication interface is configured for obtaining a present geographical position of the certification apparatus or a present geographical position of the execution unit and for extracting from the licensed data an information about a geographical position in which a usage of the information package is licensed to the user, wherein the communication interface is furthermore configured for not transmitting the license data or the authorization signal to the execution unit, if the obtained geographical position is not within a predefined range around the geographical position in which a usage of the information package is licensed to the user.

12. Method for licensing in an apparatus for enabling a usage of an information package in an execution unit, the execution unit being located exterior to the apparatus for enabling, wherein the apparatus is a portable electronic device and wherein the information package is personalized to a user by license data being assigned to the information package, the apparatus comprising:
a provider being configured for providing the license data; and
a communication interface being configured for receiving a command relating to the information package, wherein the communication interface is furthermore configured to, in response to the command, check, whether license data related to the information package are provided by the provider, and, when the license data are in the provider, transmit the license data or an authorization signal generated on the basis of the license data to the execution unit in order to enable the usage of the information package in the execution unit, wherein the method comprises the steps of:
receiving a command; and,
in response to the command, transmitting the license data or the authorization signal generated on the basis of the license data to the execution unit in order to enable the usage of the information package in the execution unit.

13. Execution apparatus for using an information package, the information package being personalized to a user by license data assigned to the information package, wherein the license data is stored in a certification unit exterior to the execution apparatus, the execution apparatus comprising:
a storage being configured for storing the information package and an enabling value;
a communication interface being configured for receiving an authorization code or an authorization signal from the certification unit, the authorization signal being generated in the certification unit on the basis of the license data stored in a storage of the certification unit; and
a processor being configured for using the information included in the information package, if the authorization code or the authorization signal is in a predefined relation with the enabling value and for not using the information of the information package if the authorization code or the authorization signal is not in the predefined relation with the enabling value.

14. Execution apparatus according to claim 13, wherein the communication interface is furthermore configured for transmitting a read-out signal to the certification unit and for receiving the authorization code or the authorization signal in response to the read-out signal.

15. Execution apparatus according to one of claim 13, wherein the communication interface is configured for wirelessly receiving the authorization code or the authorization signal from the certification unit.

16. Execution apparatus according to claim 13, wherein the communication interface is furthermore configure for encrypting the read-out signal before transmission to the certification unit using an encryption key or for decrypting the received authorization code or the received authorization signal using a decryption key after reception from the certification unit.

17. Execution apparatus according to claim 13, wherein the communication interface is configured for transmitting an identification information via the read-out signal, the identification information enabling the certification unit to identify an assignment of the license data to the information package.

18. Execution apparatus according to claim 17, wherein the communication interface is configured for obtaining a present geographical position of the execution apparatus.

19. Method for executing an information package using an execution apparatus, the information package being personalized to a user by license data being assigned to the information package, wherein the license data is stored in a certification unit exterior to the execution apparatus, the execution apparatus comprising
a storage being configured for storing the information package and enabling value,
a communication interface being configured for transmitting a read-out signal to the certification unit and, in response to the read-out signal, for receiving an authorization code or an authorization signal from the certification unit, the authorization signal being generated in the certification unit on the basis of the license data stored in a storage of the certification unit and
a processor being configured for using the information included in the information package, if the authorization code or the authorization signal is in a predefined relation with the enabling value and for not using the information of the information package if the authorization code or the authorization signal is not in the predefined relation with the enabling value,
wherein the method comprises the steps of:
receiving an authorization code or an authorization signal from the certification unit, the authorization signal being generated in the certification unit on the basis of the license data stored in a storage of the certification unit; and
using the information included in the information package, if the authorization code or the authorization signal is in a predefined relation with the enabling value and not using the information of the information package if the authorization code or the authorization signal is not in the predefined relation with the enabling value.

20. Method according to claim 19, further comprising the step of:
transmitting a read-out signal to the certification unit and wherein the step of receiving is performed in response to the read-out signal.

21. Computer program having a program code for performing the method for licensing in an apparatus for enabling a usage of an information package in an execution unit, the execution unit being located exterior to the apparatus for enabling, wherein the apparatus is a portable electronic device and wherein the information package is personalized to a user by license data being assigned to the information package, the apparatus comprising:
a provider being configured for providing the license data; and
a communication interface being configured for receiving a command relating to the information package, wherein the communication interface is furthermore configured to, in response to the command, check, whether license data related to the information package are provided by the provider, and, when the license data are in the provider, transmit the license data or an authorization signal generated on the basis of the license data to the execution unit in order to enable the usage of the information package in the execution unit, wherein the method comprises the steps of:
receiving a command; and,
in response to the command, transmitting the license data or the authorization signal generated on the basis of the license data to the execution unit in order to enable the usage of the information package in the execution unit,
when the computer program runs on a computer.

22. Computer program having a program code for performing the method for executing an information package using an execution apparatus, the information package being personalized to a user by license data being assigned to the information package, wherein the license data is stored in a certification unit exterior to the execution apparatus, the execution apparatus comprising
a storage being configured for storing the information package and enabling value,
a communication interface being configured for transmitting a read-out signal to the certification unit and, in response to the read-out signal, for receiving an authorization code or an authorization signal from the certification unit, the authorization signal being generated in the certification unit on the basis of the license data stored in a storage of the certification unit and
a processor being configured for using the information included in the information package, if the authorization code or the authorization signal is in a predefined relation with the enabling value and for not using the information of the information package if the authorization code or the authorization signal is not in the predefined relation with the enabling value,
wherein the method comprises the steps of:
receiving an authorization code or an authorization signal from the certification unit, the authorization signal being generated in the certification unit on the basis of the license data stored in a storage of the certification unit; and
using the information included in the information package, if the authorization code or the authorization signal is in a predefined relation with the enabling value and not using the information of the information package if the authorization code or the authorization signal is not in the predefined relation with the enabling value,
when the computer program runs on a computer.
